(19) United States
(12) Patent Application Publication
(10) Pub. No.: US 2022/0270178 A1
(43) Pub. Date: Aug. 25, 2022

(54) HOLISTIC DIGITAL CLAIMS PLATFORM MANAGEMENT

(71) Applicant: State Farm Mutual Automobile Insurance Company, Bloomington, IL (US)

(72) Inventors: William Simonovich, Sugar Hill, GA (US); Jordan Leach, Atlanta, GA (US); Brittany Boyer, Roswell, GA (US); Benjamin Tarmann, Heyworth, IL (US)

(21) Appl. No.: 17/668,223

(22) Filed: Feb. 9, 2022

Related U.S. Application Data
(60) Provisional application No. 63/150,419, filed on Feb. 17, 2021.

(51) Int. Cl. G06Q 40/08; G06F 3/0488

(52) U.S. Cl. CPC G06Q 40/08; G06F 3/0488

(57) ABSTRACT

A system for generating personalized recommendations for situations facing a user holding an insurance policy and providing dynamic user interfaces via an insurance platform is disclosed. The system can receive information regarding the situation and can access databases of information regarding past situations associated with the user and/or other, similar users to identify service providers that are equipped to address the situation.

### CROSS REFERENCE TO RELATED APPLICATIONS

This application claims priority to U.S. Provisional Patent Application No. 63/150,419, filed Feb. 17, 2021, the entire contents of which are incorporated herein by reference.

### BACKGROUND

Traditionally, insurance claims have been handled by insurance adjusters walking customers through the entire claims process, including assisting with documentation gathering. However, in today's digital world, customers embracing smart technologies may prefer to expedite portions of the process. For instance, instead of scheduling and waiting for an adjuster to travel and take photos of damaged property, most customers have smartphones that are capable of taking high resolution photos and videos. These customers can take photos and videos of not only the damaged property (e.g., a damaged vehicle), but also of an accident scene right after the incident, when details are fresh. With the ability to quickly send and receive data, e.g., via a smartphone, customer expectations of ease in filing and tracking claims have similarly increased. Customer expectations of an integrated experience that allows the customer to easily access information and services related to their claims have also increased. Accordingly, there is a need for an intuitive and integrated digital claims platform that can guide customers and other users through the claims process. Insurance claims are usually filed during difficult times involving loss of property and even life. Thus, there is also a need to provide excellent service and timely results to people experiencing these losses.

### SUMMARY

Embodiments of the present disclosure are directed to a system comprising one or more processors and computer-readable media storing computer-readable instructions that, when executed by the one or more processors, cause the one or more processors to perform operations. The operations include receiving first information, indicative of a user identifier, via a network, accessing, based at least in part on the user identifier, second information associated with a user corresponding to the user identifier, generating a user interface based at least in part on the user identifier and the second information, receiving, via the network, third information indicative of an occurrence of an event, accessing one or more rules associated with the user identifier, wherein the one or more rules comprise an association between the event and one or more solutions to the event, identifying a solution of the one or more solutions based at least in part on the first information, the second information, and the one or more rules, and generating an updated user interface, the updated user interface including fourth information indicative of the solution.

Further embodiments of the present disclosure are directed to one or more non-transitory computer-readable media storing instructions that, when executed by one or more processors of a computing device, cause the computing device to perform operations. The operations comprise receiving a user identifier via a network, generating, based at least in part on the user identifier, a user interface, receiving, via the network, second information including an indication of an occurrence of an event, accessing, based in part on the second information, third information from a database, the third information including at least one of preferences associated with the user identifier or one or more rules corresponding to one or more situations and solutions, determining, third information, a solution associated with the user identifier, and generating an updated user interface, the updated user interface including the solution.

Further embodiments of the present disclosure are directed to a method that comprises receiving a user identifier via a network, generating, based at least in part on the user identifier, a user interface, receiving, via the network, first information associated with an event, determining, based at least in part on the first information and the user identifier, second information associated with a solution to a situation associated with the event, and generating an updated user interface including third information, the third information including the solution and a recommendation based at least in part on the user identifier.

### BRIEF DESCRIPTION OF THE FIGURES

FIG. 1 is an overview diagram of a system for managing insurance claims according to embodiments of the present disclosure.

FIG. 2 is an illustration of an insurance claims management system according to the present disclosure.

FIG. 3 is another schematic illustration of a system for providing services to a customer of an insurance provider according to embodiments of the present disclosure.

FIG. 4 is a block diagram showing a method according to embodiments of the present disclosure.

FIG. 5 is a block diagram of a method according to embodiments of the present disclosure.

FIG. 6 illustrates an example system for implementing the holistic digital claims platform, as described herein.

### DETAILED DESCRIPTION

This disclosure is directed to a holistic digital claims platform that provides an integrated, intuitive, and customized user interface to guide a customer through the claims process. In the following detailed description, references are made to the accompanying drawings that form a part hereof, and that show, by way of illustration, specific configurations, or examples. The drawings herein are not drawn to scale. Like numerals represent like elements throughout the several figures (which might be referred to herein as a “FIG.” or “FIGS.”). Any or all of the foregoing examples may be implemented alone or in combination with any one or more of the other examples.

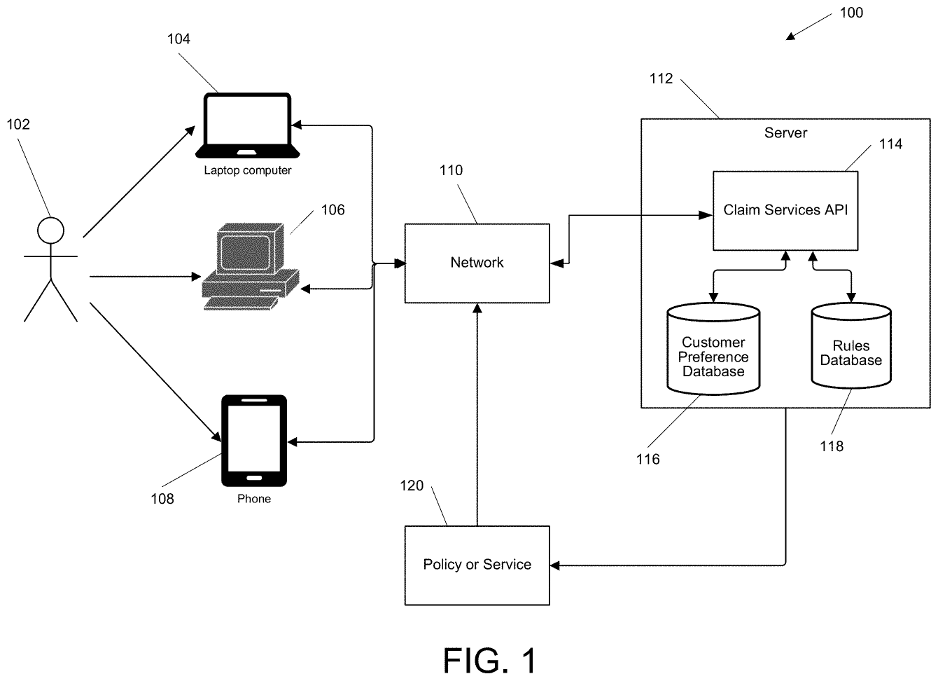

FIG. 1 is an overview diagram of a system 100 for managing insurance claims according to embodiments of the present disclosure. The system 100 can be accessed by a customer 102 via one or more devices such as laptop computers 104, desktop computers 106, or mobile devices 108. These communication devices interact with a network 110 to communicate with a server 112. The server 112 can be a single computing device, system, or network of computing devices connected together to execute the systems and methods of the present disclosure.

The server 112 executes application programming interfaces (“APIs”). The APIs comprise a claim services API 114, that can provide the services, and execute the methods and algorithms disclosed herein to manage insurance claims for the customer 102. The APIs additionally or alternatively comprise: a claim activities experience API (not shown) (e.g., retrieves one or more activities that a customer needs to complete that are associated with a claim, such as from an activities database associated with the service provider and/or any other API. May run one or more rules to validate whether the customer is authenticated to see the activities that are returned to them (e.g., such as whether the customer's insurance coverage covers the activity returned)), a user communication API 208 (described in greater detail below), a claim information API (e.g., receives a security token and accesses and/or retrieves information associated with a customer, claim(s) associated with the customer, property associated with the customer, etc., or any other information associated with the customer and/or user identifier based on the security token received. The claim information API may additionally or alternatively retrieve customer agent information, claim handler information, vehicle information, claim status information, customer policy information, customer policy coverage information, repair service information. The claim information API may interact with any other API described herein or utilized by the described system), a userID API (e.g., can provide a unique, user identifier that is generated by the system 100 and unique to a particular customer, which can be used to associate information and/or rules with the customer and/or identify the customer when the application 114 is accessed), a payments API (e.g. enables customers to make payment, retrieves information associated with past payments, retrieves back information associated with a claim, retrieves payment preferences associated with the customer, enables a customer to opt-in to use digital payment methods (e.g., such as Venmo, Paypal, etc.) to receive payments. May interact with one or more additional APIs associated with the techniques described herein), a media API (e.g., can perform document upload and/or document functions), a claim status API (e.g., retrieves and/or accesses information associated with a current status of a claim, such as accessing a status database associated with the service provider and/or interacting with one or more other APIs), an authentication API (e.g., may perform authentications operations similar to and/or the same as the userID API noted above. For instance, the authentication API may perform one or more calls that enable self-service customers to authenticate. For example, a first call may enable a customer to pass claim information and customer information that is used to validate that the customer has access to the claim and provides a security authorization token. Another such call may enable a customer to pass information (e.g., user name, password, etc.) to validate the customer. Still another such call may enable the authentication API to retrieve information associated with a security level of a customer based on a security token associated with the customer). The authentication API may interact with any other API described herein or utilized by the techniques described herein), a preferences API (enables a customer to retrieve communication preferences, opt in or out of communications, and set any preferences the customer may have. The preferences API may interact with any of the APIs described herein or utilized by the techniques described herein), a repair API (e.g., configured to surface information associated with repair companies and/or otherwise assist with repair services), a rental API (retrieves and creates rental reservations, interprets rules to determine whether a customer is eligible to obtain a rental and/or reservation with a preferred partner of the service provider, provides information associated with the rental (e.g., cost, duration, etc.). May interact with one or more additional APIs associated with the techniques described herein), an estimates API (retrieves and/or accesses information associated with estimates for claims, such as automobile estimates, fire estimates, etc., and enables a customer to upload photos, videos, or other media), a help API (e.g., used to provide a customized help information to a customer based on a customer's specific claim and/or where the customer is at in the claims process (e.g., based on compliance claim information, participants on the claim, claim status, help content, etc.), may access information from one or more additional APIs and/or a claim help database associated with the service provider),), and/or a claim loss API (e.g., used to file insurance claim(s), such as a loss report. The claim loss API may take the loss report and populate it with information accessed by one or more other APIs, such as customer information API, policies API, etc.)). In some examples, one or more of the above APIs may be omitted, replaced, or combined. In some examples, one or more additional APIs may be utilized and/or accessed by the system, such as third-party APIs.

In some examples, one or more of the APIs and/or processor(s) of the server 112 may be used to generate one or more user interfaces for display and/or presentation to a user, such as via an application and/or webpage associated with the server 112.

The server 112 can also include one or more database(s), such as a customer preference database 116, a rules database 118, a claim help database (not shown), a status database (not shown), or any other database described herein, which operate in concert with one or more of the APIs described above. For instance, the claim services API 114 may access a customer preference database 116, a rules database 118, or any other database described herein. The claim services API 114 uses the information in the databases to generate a policy or service 120 offered back to the customer 102 via the network 110. The policy or service 120 offered can be based at least in part upon information stored in the customer preference database 116 and the rules database 118. In this way, the policy or service 120 is more personalized to the customer's 102 experience. Accordingly, the techniques described herein may generate a policy or service 120 and/or recommendation that is more tailored and results-oriented compared to conventional systems.

The customer preferences database 116 can store a variety of information. For instance, some information in the customer preference database 116 can be gleaned (e.g., extracted) from public records. Some events that involve an insurance claim have public data associated with the event. Some events are large in scale, such as hurricanes and earthquakes and the like and general information about these events can populate the customer preference database 116. The customer preference database 116 also stores preferences of customers. Each customer can have an account with the insurance provider and preferences stored in the customer preference database 116 can be unique to each individual customer. The preferences stored in the customer preference database 116 comprises a history of events associated with each individual customer.

An “event” may comprise any interaction with the insurance provider and/or server 112, whether or not the event is one that is controlled by the insurance provider and/or server 112 directly (e.g., such as through a website, application, or other associated with the insurance provider) or is handled primarily by a third-party service (e.g., repair shop, rental service, hotel or lodging, etc.). Examples of events can be accessing an application, uploading media (images, documents, audio, video, etc.) associated with the user identifier, selecting a help topic, purchasing insurance, modifying insurance coverage, filing an insurance claim, paying a bill, logging into an account, receiving an update associated with a user identifier (e.g., such as from a third party and/or API), receiving an estimate associated with a user identifier, scheduling updates, or any other measurable event that is relevant to the to the customer and/or user identifier. The different types of events result in different indicia that can be used to record the event. For example, an interaction via a website can be recorded directly by the website or service hosting the website and can consist of clicks, legal agreements executed via the website, and other such indicia pertaining to the event. In the case of hiring a mechanic to repair a car, the indicia may be a payment or receipt processed or facilitated at least in part by the insurance provider and/or server 112. Each interaction or event can be stored in the customer preference database 116 and associated with the customer (e.g., as a “history of events”). The history of events in the customer preference database 116 can be built over time as a relationship between the insurance provider and the customer develops. The customer may also be invited to share details (e.g., user experience, previous claims, or any other information) about their past relationships with insurance providers to build the history. In some cases, information is publicly available that may pertain to the history and can be separately gleaned from other available sources to compile the history. The history can include the customer's use of third-party service providers 210 such as repair workers, vendors, automobile repair work, or the like. In any of the examples described herein the interactions, events, and/or other information received via one or more of the intake channels described above can be stored in the customer preference database 116. Such information may be, for example, sent to the customer preference database 116 by the preferences API and/or by any other APIs associated with, used by, and/or run by the server 112.

The rules database 118 contains rules associating events including insurance claims to service providers 210. In a non-limiting example, an insurance claim for automobile damage can be linked to automobile repair shops. The rules database 118 is shown as being separate from the customer preference database 220 but it is to be understood that in operation the databases may be maintained on the same server or other storage device. The rules in the rules database 118 can be continuously maintained and updated based on individual customers' experiences and input. The rules can also be specific to certain service providers 210. For example, a customer may have a preferred automobile repair shop they use when there are issues with their automobile. When the system logs an event related to that automobile, the preferred shop can be associated with the automobile. This is a non-limiting example of a rule stored in the rules database 118. Other examples can be specific to an individual vendor, such as an auto repair shop or a contractor. In a further example, a customer may have two automobiles that are associated with different repair shops. The rules database 118 can store a rule associating the first automobile with the first repair shop and the second automobile with the second repair shop. Rules can include any association with a certain vendor, and can including a rating metric on a spectrum from a good result on one end of the spectrum to an undesirable result on the other. A numerical value for the rating can be included in the rules database 118 and the better the rating metric is, the more heavily the rule weighs in future recommendation situations.

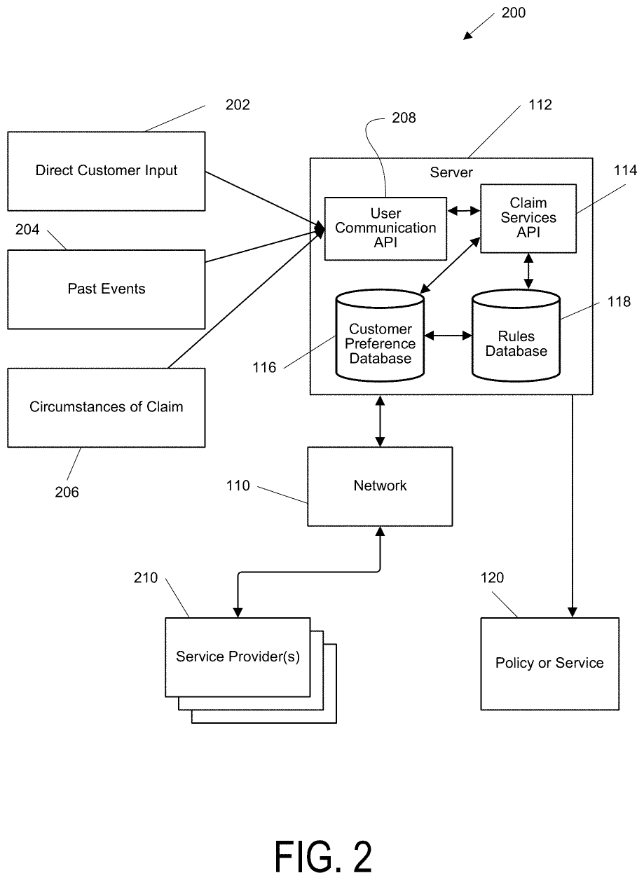

FIG. 2 is another illustration of an insurance claims management system 200 according to the present disclosure. The system 200 can be operated by an insurance policy issuer or a third-party service that manages insurance policies. The system 200 can include a server 112, which houses and executes a claim services API 114. The server 112 can interact with databases such as customer preference database 116 and rules database 118, as described in FIG. 1 above.

The server 112 can run a user communication API 208 that can facilitate communication with the customer such as by receiving text messages from a mobile phone 108 or tablet (e.g., computer 104), sending and receiving email communications, and exchanges of information through a website or a chat program. The customer preference database 116 can receive information through the user communication API 208 in the form of direct customer input 202. Such direct information can include information such as name, address, and details of an insurance claim entered into a website interface. The customer preference database 116 can also receive information associated with past events 204 including insurance claims or other interactions between the insurance provider and the customer. Some of this past information is stored on the customer preference database 116. The customer preference database 116 can also store regarding circumstances of the claim 206 which may also include information from outside sources including public sources such as police records, real estate records, fire department records, and others. The information stored in the customer preference database 116 can be used by one or more of the APIs described above with regard to FIG. 1, to help the customer in the event of a new insurance claim.

The system 200 includes a claim services application programming interface (API) 218 that executes rules and algorithms to offer service to a customer. The claim services API 114 can communicate with the customer preferences database 116 and the rules database 118. The claim services API 114 can be event-driven and can use any measurable event as a basis for action.

The claim services API 114 can also interact via a network 221 with various service providers 210 to exchange information regarding services provided, rates, repair jobs, etc. Where permitted by the customer and the various individual service providers 210 the claim services API 114 can receive customer-specific information regarding the state of repairs or other services (e.g., services being performed, services to be performed, etc.) in relation to the insurance claim. With this information, the claim services API 114 can offer to the customer, through the user communication API 208, a recommendation for a service provider 210 that is, for example, familiar to the customer, located within a customer's preferred distance (e.g., within approximately 20 miles), and/or corresponds to an event logged by the claim services API 114. In an example, a customer may use a computing device to provide information to the claim services API 114 related to a claim associated with damage to an automobile. The claim services API 114 can access, from one or more of the customer preference database 116, the rules database 118, or any database described herein, information regarding the automobile and services that has been provided in the past. The claim services API 114 can offer to the customer, via the user interface, access to the same service provider 210 that worked on a similar matter in the past. The access can be via a link or an advertisement, an email, a text message, or any other suitable communication.

In other embodiments the customer may not have had specific experience with a certain service provider 210, but the customer preference database 116 can provide information to the claim services API 114 pertaining to experiences of other customers. The customer preference database 116 can include information pertaining to many other customers and their experiences with different services. The claim services API 114 can offer to the customer a repair shop that has shown favorable results for a similar issue for other customers. Third-party service providers 210 may maintain databases of information on their own that they may wish to share with the claim services API 114. In other embodiments the customer preference database 116 can store information for each of the various individual service providers 210 and over time the level of service of each service provider 210 can be recorded. There can be a level of service for different offerings at a certain shop. For example, an automobile repair shop may specialize in servicing Toyota® automobiles, but may be less experienced with servicing Honda® automobiles. The level of service can be even more specific such as certain service tasks that can be performed on the automobiles. One shop may excel at automobile body work while another shop may excel at paint work. For each specific service offered by each shop, the claim services API 114 can maintain a score (e.g., such as storing customer reviews or third-party reviews for each shop) of how well this service is executed. The information can also be recorded at the rules database 118 that links claims to services. Additionally or alternatively, the claim services API 114 and/or one or more of the other APIs noted herein may be configured to provide additional services to the customer. For example, the claim services API 114 may also provide information identifying one or more towing companies, one or more car rental agencies, etc. In such examples, the claim services API 114 may comprise a claim repair services API or other like API run by the server 112.

In some embodiments a customer has direct experience with a service that is provided by one of the service providers 210. In that case, and to the extent the customer preference database 116 contains sufficient information about the service providers 210, the claims services API 218 can make a repeat recommendation. As will be described in greater detail below, the rules database 118 retains information indicating that an event such as a filing of a claim is similar to a past claim, and identifies that the customer has had a similar issue in the past and knows how well the last service provider 210 was able to meet the needs of the customer. In that case the claims services API 114 can make a recommendation to go back to the same service provider.

After gathering this information, in response to an event, the claim services API 114 is able to make a recommendation to the customer to offer services of a certain service provider 210 that is relevant to the event. Accordingly, the system 200 provides an enhanced and more personalized customer experience by utilizing customer preferences to know what services to offer or recommend and displaying the recommendation when the services is available for the customer.

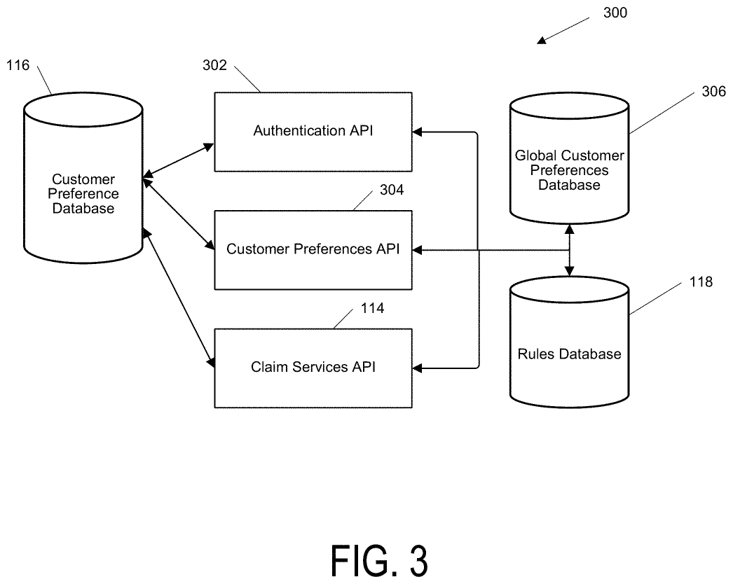

FIG. 3 is another schematic illustration of a system 300 for providing services to a customer of an insurance provider according to embodiments of the present disclosure. The system 300 includes the customer preference database 116, described above with respect to FIG. 1, that stores information pertaining to a specific customer based on their experiences with the insurance provider and/or any other provider. As noted above, the information stored in the customer preference database 116 can include a history of the customer's use of insurance products provided by the insurance provider, and it can also include a history of experiences with a number of third-party service providers 210. The system 300 can access third-party information when possible and subject to limits on information exchange.

The system 300 also includes several APIs such as an authentication API 302, a customer preference API 304, the claim service API 114, and any of the other APIs described above with respect to FIG. 1. In some embodiments these entities operate in concert and can involve some level of overlap, and it is to be understood that the division, if any, between these various APIs is not necessarily a limiting factor of the system 300. In some examples, one or more of the APIs described above with respect to FIG. 1 can be stored in the server 112 or in a service associated with a third-party server (e.g., Amazon Web Services (AWS), or the like). For example, one or more of the authentication API 302, customer preference API 304, or the claim service API 114 can be stored in the server 112 or in a service associated with a third-party server (e.g., Amazon Web Services (AWS), or the like).

The authentication API 302 can utilize information associated with the user (e.g., claim ID, user ID, whether the user has an insurance policy associated with the service provider system, etc.) to generate a uniform resource locator (URL), that is provided to a user 102 (e.g., via text, email, etc.) by the system 300 and/or a third-party system, such as a third-party service provider 210 (e.g., repair shop, rental service, hotel, etc.). The URL can be generated to comprise one or more pieces of information associated with the user (e.g., claim ID, user ID, whether the user has an insurance policy associated with the service provider system, etc.), that a processor of the system 300 can use to provide a customized user interface to the user 102. Additionally, the authentication API 302 can generate a security token that includes an indication that the user has not logged into a user account associated with the system 300. In some examples, the URL can further comprise the security token. In some examples, the authentication API 302 can receive the information associated with the user as input and utilize the information to generate the security token. In some examples, the security token can correspond to an authentication level. For instance, if the user has not logged into a user account associated with the system 300, the security token can be associated with a first authentication level (e.g., indicating the user has not been fully authenticated). The processor can utilize the security token to determine, based on the first authentication level, that sensitive information (e.g., claim estimates, payment information, uploaded files, documents, etc.) associated with the user should not be included for display on user interface 200a. When the user logs into an account associated with the system 300 (or creates an account associated with the system 300), the authentication API 302 also generates a security token. This security token can be associated with a second authentication level (e.g., indicating the user is fully authenticated). The processor of the system 300 then receives the security token associated with the second authentication level as input from the authentication API and causes a user interface to be displayed. Accordingly, the digital claims platform can utilize the security token to intelligently provide a personalized cohesive user experience, while still protecting sensitive user information.

The customer preferences API 304 can facilitate access to and population of information in the customer preference database 116. For example, the customer preferences API 304 can eliminate duplicate data entries and can identify individuals (e.g., customers) in order to map how different customers and their various information overlaps. In this way, the customer preferences API 304 can organize and curate information in a useful manner.

The claim services API 114 may be configured to identify how to handle an insurance claim corresponding to a particular situation, and in some cases may include contacting a third-party service provider 210. As explained above, the claim services API 114 can recommend a third-party service provider 210 to the customer. For instance, in the system 300 illustrated in FIG. 3, the claim services API 114 may provide the recommendation to the processor for display via a user interface provided by the system 300 and according to the guidelines set forth herein.

These APIs can also access a global customer preference database 350 which can store information regarding multiple customers who may be facing similar situations to the customer who is submitting the claim or other qualifying event. The data in the global customer preferences database 306 can be anonymized and aggregated in a way to allow the system 300 to provide excellent service to a customer based on information learned from handling similar situations for other customers.

The system 300 also includes the rules database 118 described above with respect to FIG. 1. The rules database 118 contains rules that govern an association between a situation facing a customer corresponding to an event, and possible solutions to that situation. In an example, an event may be an insurance claim and a corresponding situation may be fire damage to a home, and a solution to that problem may include contacting a fire department, a building inspector, an insurance claims adjuster, lodging options (e.g., hotels, motels, rental properties, etc.), grief counseling, and other services. The rules associate the solutions to the situations and can be updated continuously as the system 300 operates. Where a solution is recommended and results in a favorable outcome for the customer, the rule that formed the basis for the recommendation can be strengthened. And vice versa if the outcome is less than favorable the rule can be weakened. Accordingly, over time, the rules database 118 and associated APIs learn how to suit the needs of customers.

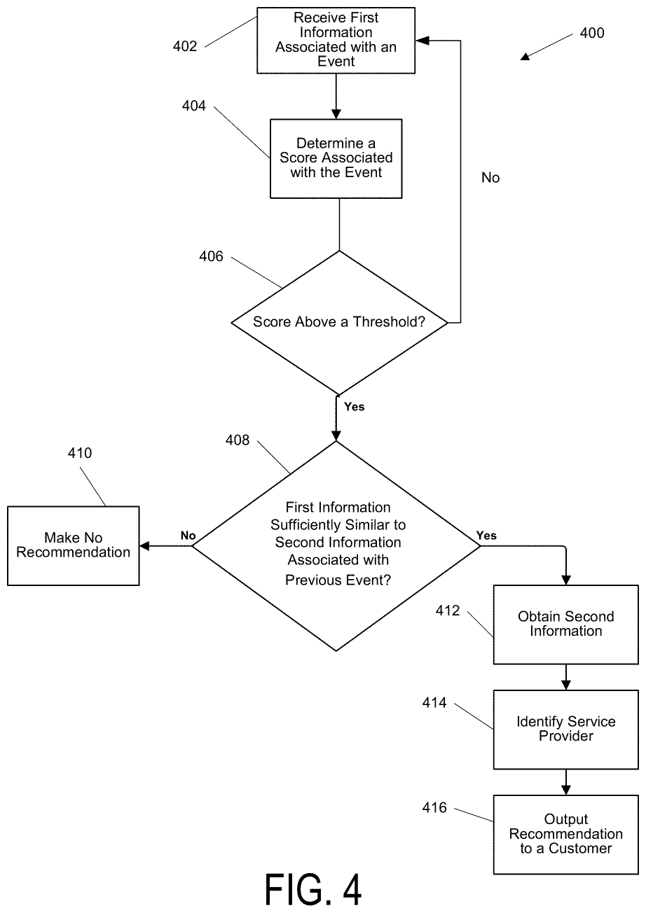

FIG. 4 is a block diagram showing a method 400 according to embodiments of the present disclosure. The method 400 can be executed by a processor, controller, server, or device as the case may be in connection with various other databases, such as the customer preferences database 116 and rules database 118, shown and described in FIG. 1, and other sources of information both internal or external. In some examples, the processor processes and/or analyzes information using machine-learning mechanisms. In some examples, inputs to the machine-learning mechanisms include eligibility of a user for a service (e.g., repair, rental, etc.), an event the user should complete (e.g., such as a specific action (setting their opt-in preference for payment, etc.)).

Machine-learning mechanisms include, but are not limited to supervised learning algorithms (e.g., artificial neural networks, Bayesian statistics, support vector machines, decision trees, classifiers, k-nearest neighbor, etc.), unsupervised learning algorithms (e.g., artificial neural networks, association rule learning, hierarchical clustering, cluster analysis, etc.), semi-supervised learning algorithms, deep learning algorithms, etc.), statistical models, etc. In at least one example, machine-trained data models can be stored in memory associated with the server 112 and/or any other device described herein.

At 402, the method 400 includes receiving first information associated with an event. For example, at 402 a processor of the server 112 (FIG. 1) or another network computing device may receive the first information indicative of an event. Many events may initiate with a customer using a user interface to contact a server 112 executing instructions according to the disclosed embodiments herein. Other events can initiate elsewhere, such as if a service provider 210 completes a job or processes a payment pertaining to the customer and the customer's insurance policy. As described above, example events can include logging into a web browser to file an insurance claim, opening an application on a smartphone, or the like. Some events are not significant enough to warrant execution of the entire method 400 and may result in partial operation of this method 400.

At 404 the processor determines a score associated with the event. The score can be based on one or more factors (e.g., claim information, policy information, vehicle information, or any information associated with the customer and/or feedback received from the customer). The processor may use the one or more factors to determine whether or not a service recommendation is expected. The processor can determine the score of an event based on empirical observation of past events. In one example, customer feedback after receiving a service provider recommendation is stored in association with the event and/or other events that caused the method 400 to initiate. If the feedback was positive, other, similar events in the future are more likely to have a higher score. Conversely, if the customer feedback is negative, the events that are linked to that feedback can be determined to have a lower score.

At 406, the processor determines if the score associated with the event is above a threshold. In some examples, the threshold is a predefined based on the event type (e.g., automobile, fire, home, etc.). For example, if the processor determines the event has a low score (e.g., the score is below a threshold score), which results in the processor recording (e.g., logging) the event. In this example, the processor determines that no recommendation is needed and no further action is taken by the processor, so control returns to 402 to wait for the next event. For instance, the score may be below a threshold score where the event does not require a recommendation (e.g., such as the customer logging into a customer account, the customer making a payment, etc.). Where the processor determines the event has a score higher than the threshold, the method 400 continues to 406.

At 408 the processor determines whether or not the first information indicative of an event received at 402 is sufficiently similar (e.g., a similarity above a threshold (e.g., such as above a threshold of 1 match in policy/coverage, type of rental, type of action, type of event, etc.)) to other information associated with a previous event represented by second information stored in customer preference database 116, a rules database 118, and/or a global customer preference database 306, as described above with respect to FIGS. 1 and 3. For example, at 408 the processor may compare the first information to second information associated with one or more other customers to determine similarity. The second information can be accessed by the processor from the global customer preference database 306. For example, the first information can include an indication of damage to property associated with a customer, in which case the property in question may be described (e.g., house, car, dishwasher, etc.). In this example, the processor then identifies, from the second information, other events involving one or more similar parameters (e.g., involving a same type of property, a dollar value associated with the property, a dollar value associated with repairing or replacing the property, a location of the property, the date, the communication source of the event (website, phone, etc.), or the like).

If the processor determines that the first information is not sufficiently similar to the second information, at 410 the processor makes no recommendation, and the method terminates. On the other hand, if the processor determines that the first information is sufficiently similar to the second information, the method proceeds to 412.

At 412 the processor obtains second information pertinent to making a recommendation. For instance, the processor may access a customer preference database 116 and/or a rules database 118, as described above with respect to FIG. 1. Obtaining the second information includes identifying which services and which service providers 210 are best suited to handle the situation currently facing the customer. The second information can also include customer information associated with the specific customer and/or one or more other customers determined to be similar to the specific customer, which can be used by the processor, in order to further personalize the recommendation for the specific customer. For instance, the one or more other customers may be determined to be similar to the specific customer based on one or more of demographic info, shared preferences, accident history, repair history, policy information, coverage information, location, or any other information.

At 414 the processor identifies a service provider 210 that best suits the situation according to the rules in the rules database 118 and the customer's preferences stored in the customer preference database 116. For example, a customer may have previously used or designated a particular automobile repair shop when filing an automobile claim. In this example, the automobile repair shop is stored in the customer preference database 116 in association with the customer. Accordingly, when the customer files another automobile claim, the rules in the rules database 118 can indicate that the customer has previously made an automobile claim and the processor can access the customer preference database 116 to identify which automobile repair shop the customer has previously used or designated. In some examples, the customer may not have any preferences stored in the customer preference database 116. In this example, the processor can utilize customer information (e.g., the type of vehicle the customer owns, the customer's current location, a stored location (e.g., customer's home address, work address, etc.) associated with the customer, stores close to the customer's current location or stored location, etc.), feedback associated with one or more service providers 210, and/or information associated with similar customers (e.g., such as customers in a similar location, with a similar vehicle, etc.) to identify a service provider 210 that best suits the situation.

At 416 the processor outputs a recommendation to the customer via a user interface. As indicated above, the recommendation can be based on the customer's previous experience with the service provider, designated customer preferences, or the like. Accordingly, the system 400 is able to provide personalized recommendations (utilizing rules and customer preferences) that are tailored to the specific circumstances (e.g., event) of the customer.

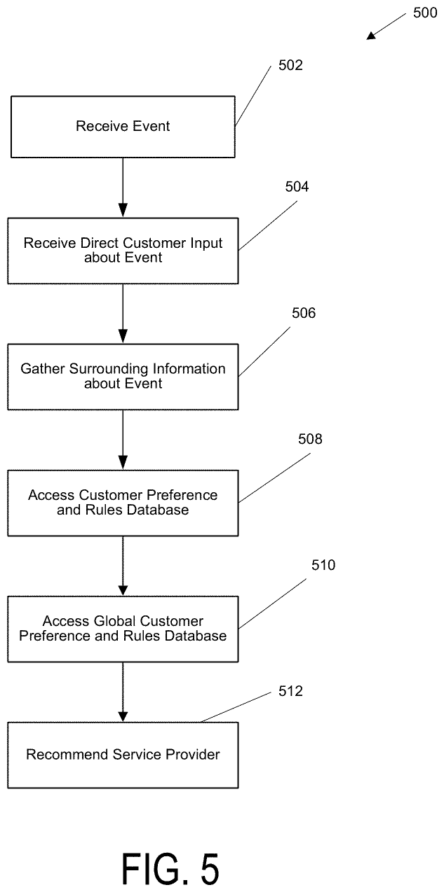

FIG. 5 is a block diagram of a method 500 according to embodiments of the present disclosure. The method 500 can be executed by the systems disclosed herein. In some embodiments the method 500 is executed by a processor on a server such as server 112 shown in FIG. 1. The method 500 includes receiving an event at 502 either from direct customer input 202, such as when the customer logs into a website or initiates an application on a smartphone or other device, or from any other measurable act defined as an event elsewhere herein. At 504 the processor receives information about the event and stores the information in a database. The customer can describe the event in terms of location, damage, services needed, names and identifiers of individuals involved, police reports or other records from public services such as fire services or ambulances, etc. At 506, the processor receives surrounding information regarding the event. The surrounding information may be gleaned from public records or from social media or other sources of information.

At 508 the processor accesses a customer preference database 116 and a rules database 118 for service provider 210 options that may be suitable for a recommendation to suit the event. For example, if the event is a rat infestation in a house, the customer preference database 116 may have information about a previous rat infestation in the same house, and the name and contact information of the service provider who helped with the previous infestation may be part of the information in the customer preferences database 116. Information that is specific to the customer associated with the event may be given a higher weight in scoring because of the customer's direct involvement.

At 510 the processor accesses a global customer preferences database 306 and rules database 118. The information in the global databases can also be used to provide a useful policy or service offering. For example, an event may correspond to a rat infestation, which the processor logs in association with a customer and the customer's address. In this example, the processor also determines this is the first rat infestation the customer has experienced at any stored address associated with the customer. The global customer preferences database 306 may have information about the house next door which had a similar rat infestation. For instance, the global customer preference database may be able to store the name and contact information of the extermination provider who handled the house next door. The system can maintain privacy by anonymizing the data. At 512, the service provider 210 is recommended. For instance, where the global customer preference database is accessed, the system can provide the recommendation with a message such as “a similar infestation has happened nearby and ACME Rat Exterminators handled the situation.” Where permitted, the message may also include the recommendation with a review by the owner of the house that had the infestation.

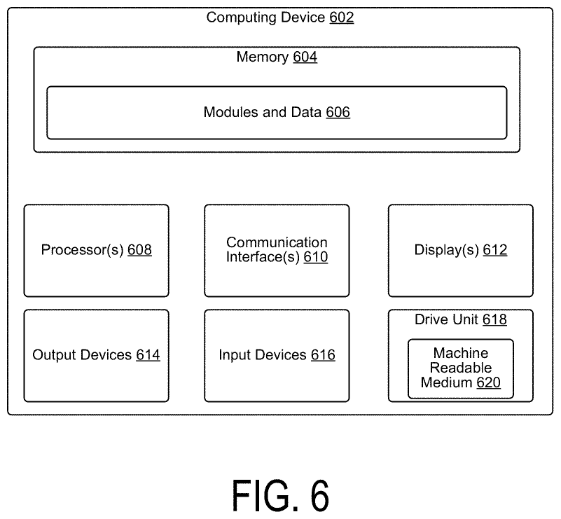

FIG. 6 shows an example system architecture for a computing device 602 associated with the system 100 or the claims management system 200, as described in FIGS. 1 and 2 above. A computing device 602 can be a server 112, computer 104, or other type of computing device that executes at least a portion of system 100 or claim management system 200. In some examples, elements of the system 100 or the claim management system 200 can be distributed among, and/or be executed by, multiple computing devices 602.

A computing device 602 can include memory 604. In various examples, the memory 604 can include system memory, which may be volatile (such as RAM), non-volatile (such as ROM, flash memory, etc.) or some combination of the two. The memory 604 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store desired information and which can be accessed by one or more computing devices 602 associated with the customer 102. Any such non-transitory computer-readable media may be part of the computing devices 602.

The memory 604 can store modules and data 606. The modules and data 606 can include one or more of the user communication API 208, claim services API 114, or customer preferences API 304 described above. Additionally, or alternately, the modules and data 606 can include any other modules and/or data that can be utilized by the system 100 or the claim management system 200 to perform or enable performing any action taken by the system 100 or the claim management system 200. Such other modules and data can include a platform, operating system, and applications, and data utilized by the platform, operating system, and applications.

One or more computing devices 602 of the claim management system 200 can also have processor(s) 608, communication interfaces 610, displays 612, output devices 614, input devices 616, and/or a drive unit 618 including a machine readable medium 620.

In various examples, the processor(s) 608 can be a central processing unit (CPU), a graphics processing unit (GPU), both a CPU and a GPU, or any other type of processing unit. Each of the one or more processor(s) 608 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 608 may also be responsible for executing computer applications stored in the memory 604, which can be associated with common types of volatile (RAM) and/or nonvolatile (ROM) memory.

The communication interfaces 610 include transceivers, modems, interfaces, antennas, telephone connections, and/or other components that can transmit and/or receive data over networks, telephone lines, or other connections.

The display 612 may comprise a liquid crystal display or any other type of display commonly used in computing devices. For example, a display 612 may be a touch-sensitive display screen, and can then also act as an input device or keypad, such as for providing a soft-key keyboard, navigation buttons, or any other type of input.

The output devices 614 include any sort of output devices known in the art, such as a display 612, speakers, a vibrating mechanism, and/or a tactile feedback mechanism. Output devices 614 can also include ports for one or more peripheral devices, such as headphones, peripheral speakers, and/or a peripheral display.

The input devices 616 can include any sort of input devices known in the art. For example, input devices 616 can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

The machine readable medium 620 can store one or more sets of instructions, such as software or firmware, that embodies any one or more of the methodologies or functions described herein. The instructions can also reside, completely or at least partially, within the memory 604, processor(s) 608, and/or communication interface(s) 610 during execution thereof by the one or more computing devices 602 of the claim management system 200. The memory 604 and the processor(s) 608 also can constitute machine readable media 620.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. A system, comprising:
one or more processors; and
computer-readable media storing computer-readable instructions that, when executed by the one or more processors, cause the one or more processors to perform operations comprising:
receiving first information, indicative of a user identifier, via a network;
accessing, based at least in part on the user identifier, second information associated with a user corresponding to the user identifier;
generating a user interface based at least in part on the user identifier and the second information;
receiving, via the network, third information indicative of an occurrence of an event;
accessing one or more rules associated with the user identifier, wherein the one or more rules comprise an association between the event and one or more solutions to the event;
identifying a solution of the one or more solutions based at least in part on the first information, the second information, and the one or more rules; and
generating an updated user interface, the updated user interface including fourth information indicative of the solution.

2. The system of claim 1, the operations further comprising:
receiving, via the network, fifth information associated with the event from one or more third-party services; and
identifying the solution of the one or more solutions based at least in part on the fifth information.

3. The system of claim 1, wherein identifying the solution includes identifying one or more service providers, and wherein the second information comprises at least one of: one or more preferences associated with the user identifier or an indication of an experience associated with the one or more service providers.

4. The system of claim 1, the operations further comprising:
identifying fifth information associated with at least one additional user that is similar to the user, wherein the solution is determined based at least in part on the fifth information.

5. The system of claim 4, the operations further comprising:
identifying a rule of the one or more rules associating the fifth information with the event, wherein the solution is determined based at least in part on the rule.

6. The system of claim 4, wherein the first information is received from at least one of: an electronic device of the user associated with the user identifier, an application programming interface (API), or an electronic device of a third party user.

7. The system of claim 1, wherein the event comprises at least one of: accessing an application or web page, updating data associated with the user identifier, uploading documents associated with the user identifier, uploading images associated with the user identifier, selecting a help topic, logging into an account associated with the user identifier, or receiving data associated with the user identifier from a third party or API.

8. The system of claim 1, the operations further comprising:
receiving, via the updated user interface, an indication of a selection of a potential solution; and
updating the first information based at least in part on the indication.

9. One or more non-transitory computer-readable media storing instructions that, when executed by one or more processors of a computing device, cause the computing device to perform operations comprising:
receiving a user identifier via a network;
generating, based at least in part on the user identifier, a user interface;
receiving, via the network, second information including an indication of an occurrence of an event;
accessing, based in part on the second information, third information from a database, the third information including at least one of preferences associated with the user identifier or one or more rules corresponding to one or more situations and solutions;
determining, third information, a solution associated with the user identifier; and
generating an updated user interface, the updated user interface including the solution.

10. The one or more non-transitory computer-readable media of claim 9, the operations further comprising:
receiving, via the updated user interface, input including a selection of the solution; and
updating the third information based at least in part on the selection of the solution.

11. The one or more non-transitory computer-readable media of claim 9, wherein the situation comprises a first situation and the customer preference database further comprises fourth information indicative of preferences of one or more additional customers, the operations further comprising:
identifying, based at least in part on comparing the fourth information and the third information, a second situation that is similar to the first situation; and
determining the solution based at least in part on the fourth information.

12. The one or more non-transitory computer-readable media of claim 9, wherein the event comprises at least one of accessing an application or web page, updating data associated with the user identifier, uploading documents associated with the user identifier, uploading images associated with the user identifier, selecting a help topic, logging into an account associated with the user identifier, or receiving data associated with the user identifier from a third-party or API.

13. The one or more non-transitory computer-readable media of claim 9, wherein the first information is received from at least one of: an electronic device of the user associated with the user identifier, an application programming interface (API), or an electronic device of a third-party user.

14. A method, comprising:
receiving a user identifier via a network;
generating, based at least in part on the user identifier, a user interface;
receiving, via the network, first information associated with an event;
determining, based at least in part on the first information and the user identifier, second information associated with a solution to a situation associated with the event; and
generating an updated user interface including third information, the third information including the solution and a recommendation based at least in part on the user identifier.

15. The method of claim 14, further comprising:
identifying one or more rules, the one or more rules indicating an association between the situation and a plurality of third-party users.

16. The method of claim 14, wherein the first information is received from at least one of: an electronic device of the user associated with the user identifier, an application programming interface (API), or an electronic device of a third-party user.

17. The method of claim 14, further comprising:
receiving a selection of the at least one third-party user; and
updating user preferences data based at least in part on the selection.

18. The method of claim 17, wherein the user preference data comprises at least one of data associated with one or more of user contact preferences, user repair preferences, user rental preferences, or user lodging preferences.

19. The method of claim 14, wherein the event comprises at least one of accessing an application or web page, updating data associated with the user identifier, uploading documents associated with the user identifier, uploading images associated with the user identifier, selecting a help topic, logging into an account associated with the user identifier, or receiving data associated with the user identifier from a third-party or API.

20. The method of claim 14, wherein the situation comprises a first situation, the method further comprising:
identifying, based at least in part on comparing the first information and the second information, a second situation that is similar to the first situation; and
identifying the at least one third-party user based at least in part on the third information.
